(19) United States
(12) Patent Application Publication
(10) Pub. No.: US 2015/0234908 A1
(43) Pub. Date: Aug. 20, 2015

(54) TECHNIQUES FOR DATA SYNCHRONIZATION USING COMPRESSIVE SENSING

(71) Applicant: PRESIDENT AND FELLOWS OF HARVARD COLLEGE, Cambridge, MA (US)

(72) Inventors: Hsiang-Tsung Kung, Belmont, MA (US); Chit-Kwan Lin, New York, NY (US)

(73) Assignee: President and Fellows of Harvard College, Cambridge, MA (US)

(21) Appl. No.: 14/429,108

(22) PCT Filed: Sep. 24, 2013
(86) PCT No.: PCT/US2013/061286

§ 371 Date: Mar. 18, 2015

Related U.S. Application Data
(60) Provisional application No. 61/704,839, filed on Sep. 24, 2012.

(51) Int. Cl. G06F 17/30

(52) U.S. Cl. CPC G06F 17/30575; G06F 17/30876; G06F 17/30153

(57) ABSTRACT

Techniques for data synchronization between a first computing device coupled to at least one memory storing current data and a second computing device coupled to at least a second memory storing first encoded data and a copy of prior data. The first device may perform a method comprising: encoding the current data using a compressive sensing encoding technique to obtain second encoded data; and transmitting the second encoded data to the second computing device. The second device may perform a method comprising receiving second encoded data from the first computing device; decoding the second encoded data using a compressive sensing decoding technique to obtain decoded data; and obtaining a copy of the current data by using the decoded data and the copy of prior data.

### CROSS-REFERENCE TO RELATED APPLICATIONS

The present application claims the benefit under 35 U.S.C. §119(e) of U.S. Provisional Application Ser. No. 61/704,839, filed on Sep. 24, 2012, titled, “Techniques for Data Synchronization Using Compressive Sensing,” which is hereby incorporated by reference in its entirety.

### BACKGROUND

Data synchronization relates to maintaining data consistency among multiple copies of data. Data synchronization techniques are used in a variety of applications. For example, data synchronization techniques may be used to perform file synchronization (e.g., between two hard drives storing files), implement version control systems, perform mirroring (e.g., mirroring web sites on different servers), and/or synchronize data stored on one device (e.g., a mobile device) with data stored on another device (e.g., a desktop or laptop computer).

Conventional data synchronization techniques, such as the Unix program rsync, synchronize a file stored on device A and not synchronized (“out of sync”) with its copy stored on another device B by: (1) identifying regions where the file and its copy differ; (2) encoding the changes; (3) transmitting the encoded changes from device A to device B; and (4) decoding and applying the changes so that the copy of the file stored on device B may be updated and synchronized with the file stored on device A.

### SUMMARY

Some embodiments provide for a system for data synchronization. The system comprises at least one computing device; and at least one memory storing processor-executable instructions that, when executed by the at least one computing device, cause the at least one computing device to encode current data using a compressive sensing encoding technique to obtain first encoded data; and transmit the first encoded data to at least a second computing device.

Some embodiments provide for at least one non-transitory computer-readable storage medium storing processor executable instructions that, when executed by a first computing device, cause the computing device to perform a method for data synchronization between the first computing device coupled to at least one memory storing current data and at least a second computing device, the method comprising encoding the current data using a compressive sensing encoding technique to obtain first encoded data; and transmitting the first encoded data to at least the second computing device.

Some embodiments provide for a method for data synchronization between a first computing device coupled to at least one memory storing current data and a second computing device, the method performed by the first computing device. The method comprises encoding the current data using a compressive sensing encoding technique to obtain first encoded data; and transmitting the first encoded data to the second computing device.

Some embodiments entail, in response to determining that at least a threshold number of changes have been made to the current data to produce updated data, encoding the updated data using the compressive sensing encoding technique to obtain second encoded data; and transmitting the second encoded data to the second computing device.

According to some embodiments, the current data comprises a plurality of bits, the first encoded data comprises a plurality of encoded bits, and encoding the current data using the compressive sensing encoding technique comprises calculating a plurality of random linear combinations of bits in the plurality of bits to obtain the plurality of encoded bits. According to some embodiments, calculating the plurality of random linear combinations of bits comprises calculating at least one weighted sum of bits in the first plurality of bits, with bits being weighted by weights obtained at least in part by using at least one probability distribution. According to some embodiments, the at least one probability distribution comprises a distribution of a Bernoulli random variable and/or a distribution of a Gaussian random variable. Some embodiments entail transmitting the weights obtained at least in part by using at least one probability distribution to at least the second computing device.

According to some embodiments, the first computing device is a mobile device. According to some embodiments, the current data is data created and/or accessed by an application program executing, at least in part, on the mobile device. According to some embodiments, the at least one second computing device comprises a server configured to store data created and/or accessed by the application program executing on the mobile device.

Some embodiments are directed to a system for data synchronization with a first computing device coupled to at least a first memory storing current data, the system comprising at least one memory storing first encoded data and a copy of prior data; and at least one computing device coupled to the at least one memory, the at least one computing device configured to receive second encoded data from the first computing device, decode the second encoded data using a compressive sensing decoding technique to obtain decoded data, and obtain a copy of the current data by using the decoded data and the copy of the prior data.

Some embodiments are directed to at least one non-transitory computer-readable storage medium storing processor-executable instructions that, when executed by a second computing device coupled to at least a second memory storing first encoded data and a copy of prior data, cause the second computing device to perform a method of data synchronization with a first computing device coupled to at least a first memory storing current data. The method comprises receiving second encoded data from the first computing device; decoding the second encoded data using a compressive sensing decoding technique to obtain decoded data; and obtaining a copy of the current data by using the decoded data and the copy of the prior data.

Some embodiments are directed to a method for data synchronization between a first computing device coupled to at least a first memory storing current data and at least a second computing device coupled to at least a second memory storing first encoded data and a copy of prior data, the method performed by the second computing device. The method comprises receiving second encoded data from the first computing device; decoding the second encoded data using a compressive sensing decoding technique to obtain decoded data; and obtaining a copy of the current data by using the decoded data and the copy of prior data.

According to some embodiments, the second encoded data further comprises using the first encoded data to perform the decoding. According to some embodiments, decoding the second encoded data comprises applying the compressive sensing decoding technique to a difference between the second encoded data and the first encoded data.

Some embodiments involve receiving a plurality of weights from the first computing device, wherein the plurality of weights were used to obtain the first encoded data and the second encoded data. Some embodiments involve storing the second encoded data in at least the second memory.

According to some embodiments, the first computing device is a mobile device. According to some embodiments, the second computing device is a server configured to store data created and/or accessed by an application program executing on the mobile device.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same or a similar reference number in all the figures in which they appear.

FIG. 1 shows an illustrative environment in which some embodiments may operate.

FIG. 2 is a flowchart of illustrative process 200 for using a compressive sensing encoding technique to encode data in connection with performing data synchronization, in accordance with some embodiments of the disclosure provided herein.

FIG. 3 is a flowchart of illustrative process 300 for using a compressive sensing decoding technique in connection with performing data synchronization, in accordance with some embodiments of the disclosure provided herein.

FIG. 4 shows an illustrative implementation of a computer system that may be used in connection with some embodiments.

### DETAILED DESCRIPTION

Data synchronization is often performed over bandwidth-limited communication channels. The inventors have recognized that some conventional data synchronization techniques do not use the limited communication resources efficiently. For example, the program rsync, described above and used to synchronize a file stored on device A that is out of sync with its copy stored on another device B, uses communication resources between these devices to establish consensus about where the file and its copy differ before any updates to the file stored on device A are transmitted to device B. The communication required to reach such a consensus introduce an undesirable amount of communications overhead and delay. Accordingly, in some embodiments, data synchronization techniques are provided that do not require establishing a consensus about where a data block and its copy differ. Rather, when a data block is updated (e.g., a. threshold number of changes has been made to the data block) the updated data block is encoded and transmitted, and the changes that have been made to the block are identified subsequently during decoding.

Data compression plays an important role in data synchronization because data transmitted over bandwidth-limited communications channels is typically compressed prior to being transmitted. Conventional data synchronization techniques involve compressing information using an encoder (e.g., a Lempel-Ziv encoder) that requires greater computational resources (processing power, memory, etc.) to compress data than to decompress the data. The inventors have recognized, however, that in many data synchronization situations it is desirable to use a compression scheme that requires fewer computational resources to compress data than to decompress the data. For example, when the device performing the compression (e.g., a mobile phone) has access to fewer computational resources than the device performing the decompression (e.g., a server, a desktop computer, etc.), it may be desirable to use a compression scheme that uses fewer computational resources to compress data than to decompress the data. Accordingly, in some embodiments, data synchronization techniques are provided that involve encoding data so that the data is compressed as part of the encoding process and whereby performing the encoding may use fewer computational resources than performing the corresponding decoding.

Some embodiments provide for data synchronization using compressive sensing techniques. In some embodiments, performing data synchronization using compressive sensing techniques comprises using corresponding compressive sensing encoding and decoding techniques. In some embodiments, a data block accessible by device A (e.g., a mobile phone) and its copy accessible by device B (e.g., a server in the cloud) may be synchronized. After a threshold number of changes is made to the data block accessible by device A, device A may encode the updated data block using a compressive sensing encoding technique and send the encoded updated data block to device B. Device B may receive the encoded updated data block and use a compressive sensing decoding technique to identify changes made to the data block accessible by device A and make corresponding updates to the data block that device B is configured to access.

In some embodiments, encoding a data block using a compressive sensing encoding technique to produce an encoded data block may be less computationally expensive than decoding the encoded data block using the corresponding compressive sensing decoding technique. As such, encoding a data block using a compressive sensing encoding technique may require less computational resources (e.g., power, processor time, memory, etc.) than decoding the data block. This may be advantageous in circumstances where the device performing the encoding (e.g., a mobile phone) has access to fewer computational resources than the device performing the decoding (e.g., a server, a desktop computer, etc.).

In some embodiments, using a compressive sensing encoding technique to encode a data block comprises calculating a plurality of random linear combinations of bits in the data block to obtain a plurality of encoded bits. Calculating a random linear combination of bits comprises calculating a weighted sum of bits, with the bits being weighted by weights obtained by using at least on probability distribution (e.g., Gaussian distribution, Bernoulli distribution, etc.).

In some embodiments, the number of encoded bits (e.g., M, where M is an integer greater than 0) is smaller than the number of bits in the data block (e.g., N, where N is an integer greater than 0). That is, M<N. For example, in some embodiments, may be less than 50% of N, less than 40% of N, less than 30% of N, less than 25% of N, less than 20% of N, less than 15% of N, less than 10% of N, less than 5% of N, or less than 3% of N. In this way, using a compressive sensing encoding technique to encode a data block comprises compressing the data block (e.g., from N to M bits, where M may be smaller than N).

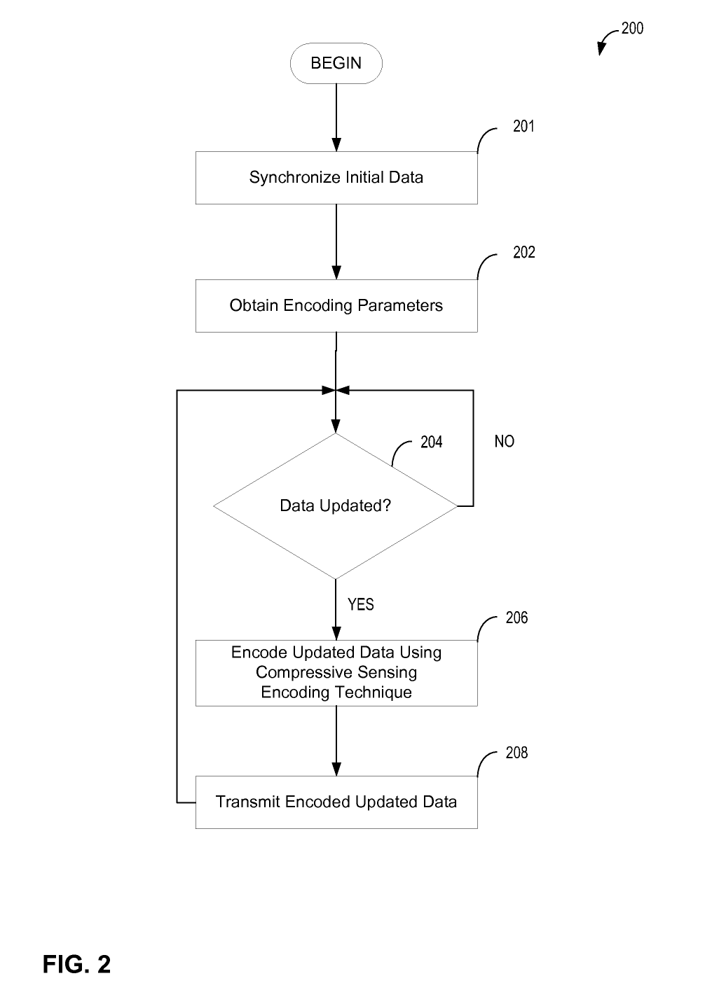

In some embodiments, using a compressive sensing encoding technique to encode a data block comprises encrypting and encoding the data block. As one non-limiting example, the data block may be encrypted by using a symmetric key and then be encoded (e.g., by calculating a plurality of random linear combinations, as described above). The inventors have appreciated that encrypting and then encoding the data block may be advantageous over conventional techniques in which encryption is performed only after encoding of the data block is completed. Compressive sensing encoding is described in more detail below with reference to FIG. 2.

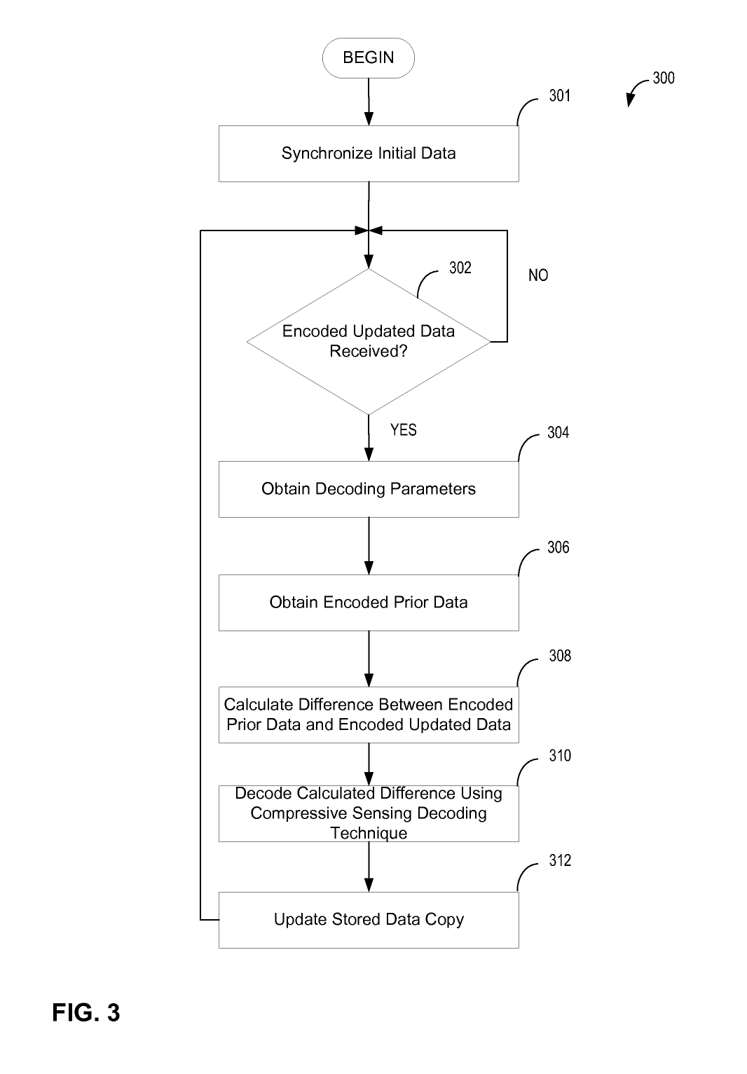

The inventors have recognized that when the number of changes to a data block is small relative to the size of the data block, a compressive sensing decoding technique may be employed to identify the changes that have been made. Accordingly, in some embodiments, using a compressive sensing decoding technique to update a prior data block based on a received encoded updated data block may comprise: (1) encoding the prior data block; (2) decoding the difference between the encoded updated data block and the encoded prior data block to identify the changes that have been made to the prior data block; and (3) using the identified changes to update the prior data block. That is, in some embodiments, using a compressive sensing decoding technique may comprise decoding the difference between the encodings of the last two versions of the data block being synchronized. Compressive sensing decoding is described in more detail below with reference to FIG. 3.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as the application is not limited in this respect.

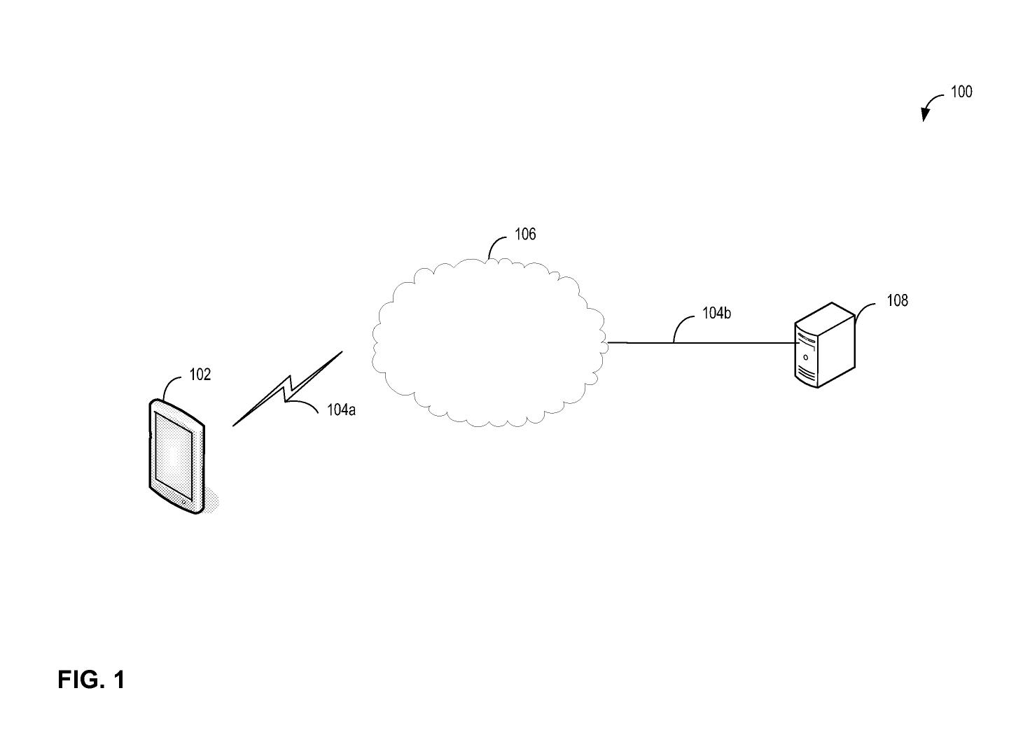

Some embodiments of the disclosure provided herein may operate in the illustrative environment 100 shown in FIG. 1. Illustrative environment 100 comprises computing device 102 and server 108 that may operate to synchronize respective copies of data accessible by the computing device 102 and server 108. In some embodiments, a copy of at least a portion of the data accessible by computing device 102 may be accessible by server 108 and, when the portion of the data accessible by computing device 102 is updated, corresponding updates may be made to the copy of the data accessible by server 108 so that the portion of the data accessible by computing device 102 is synchronized with its copy accessible by server 108. It should be appreciated that data accessible by a computing device (e.g., computing device 102, server 108, etc.) may be stored on the device, but aspects of the disclosure provided herein are not limited in this respect. For example, data accessible by a device may be stored on one or more non-transitory computer-readable storage media accessible by the device.

The copy of the data accessible by server 108 may be updated in any suitable way. In some embodiments, the copy of the data accessible by server 108 may be updated using compressive sensing data synchronization techniques including, for example, the compressive sensing encoding and decoding techniques described below with reference to FIGS. 2 and 3, respectively.

Computing device 102 may be configured to access any suitable type of data and server 108 may be configured to access a copy of at least a portion (e.g., all) of the data accessible by computing device 102. When the data accessible by computing device 102 is updated (e.g., data is added, removed, and/or edited, a threshold number of changes is made, etc.) corresponding changes may be made to the copy accessible by server 108 so that the copy of the data accessible by server 108 is synchronized with the corresponding data accessible by computing device 102.

As one non-limiting illustrative example, computing device 102 may be configured to access data created and/or accessed by one or more application programs and/or an operating system executing on computing device 102. Server 108 may be configured to access a copy of at least some of these data and, when at least a portion of the data accessible by computing device 102 is updated, corresponding changes may be made to the copy of the data accessible by server 108 so that the copy of the data accessible by server 108 is synchronized with the corresponding data accessible by computing device 102.

Examples of application programs include, but are not limited to, a document processing application program (e.g., program for performing text processing, program for performing spreadsheet processing, etc.) an e-mail application program, a calendar application program, one or more application programs for performing communications (e.g., calling, texting, and/or sending e-mail), a contacts application program, an application program configured to display photographs and/or videos, an application program configured to play, download, and/or purchase media (e.g., music, videos, movies, etc.), a web browser application program that provides access to other web-accessible application programs and/or services, and an application program providing dedicated access to a particular web application and/or service (e.g., an application program proving dedicated access to a social networking service such as Twitter® or Facebook®, an application program to provide dedicated access to other types of web services, etc.).

As another non-limiting illustrative example, computing device 102 may be configured to access media content (e.g., photos and/or other images, music, movies, books, etc.) and server 108 may be configured to access a copy (e.g., a backup copy) of at least some of the media content accessible by computing device 102. When media content accessible by computing device 102 is updated (e.g., additional media content is added, removed, and/or edited, a threshold number of changes is made, etc.), corresponding changes may be made to the copy accessible by server 108 so that the copy of media content accessible by server 108 is synchronized with the corresponding media content accessible by computing device 102.

As another non-limiting illustrative example, computing device 102 may be configured to access one or more documents (e.g., text documents, database documents, spreadsheets, etc.) and server 108 may be configured to access (e.g., store) a copy (e.g., a backup copy) of at least some of the documents accessible by computing device 102. When one or more documents accessible by computing device 102 is updated (e.g., one or more documents are added, removed, and/or edited, a threshold number of changes is made, etc.) corresponding changes may be made to the copy accessible by server 108 so that the copies of the documents accessible by server 108 are synchronized with the corresponding documents accessible by computing device 102.

In illustrative environment 100, computing device 102 is a mobile device. However, aspects of the disclosure provided herein are not limited in this respect, as computing device 102 may be any suitable computing device configured to access data. For example, computing device 102 may be a portable device such as a mobile smart phone, a personal digital assistant (PDA), a laptop computer, a tablet computer, and/or any other portable device configured to access data. Alternatively, computing device 102 may be a fixed electronic device such as a desktop computer, a server, a rack-mounted computer, and/or any other suitable fixed electronic device configured to access data. Computing device 102 may be one or multiple computing devices. Similarly, server 108 may be any suitable type of portable or fixed electronic device configured to access a copy of the data accessible by computing device 102. Server 108 may be one or multiple computing devices.

Computing device 102 is configured to communicate with server 108 via communication links 104a and 104b and network 106. Network 106 may be any suitable type of network such as a local area network, a wide area network, the Internet, an intranet, or any other suitable network. Each of communication links 104a-104b may be a wired communication link, a wireless communication link, or any other suitable type of communication link. Computing device 102 and server 108 may communicate through any suitable networking protocol (e.g., TCP/IP), as the manner in which information is transferred between server 108 and computing device 102 is not a limitation of aspects of the disclosure provided herein.

In illustrative environment 100, computing device 102 and server 108 communicate via a network. However, in other embodiments, computing device 102 and server 108 may communicate directly via a wired or a wireless link (e.g., when computing device 102 and server 108 are co-located). For instance, computing device 102 may be a user's mobile device and server 108 may be a computer (e.g., a desktop computer) and the mobile phone may establish a direct connection with the desktop computer to synchronize at least a portion of the data stored on the mobile phone.

Though the illustrative environment 100 illustrates data synchronization between two devices (i.e., computing device 102 and server 108), aspects of the disclosure provided herein are not limited in this respect. Accordingly, in some embodiments, data synchronization may be performed among more than two (e.g., three, four, five, six, ten, etc.) computing devices of any suitable type.

As described above, in some embodiments, data synchronization may be performed at least in part by using compressive sensing techniques including corresponding compressive sensing encoding and decoding techniques. After a data block accessible by device A has been copied to storage accessible by device B, device A (e.g., computing device 102) monitors the data block for changes and, when the monitored data block has changed (e.g., a threshold number of changes to the data block have been made), device A encodes the changed data block using a compressive sensing encoding technique and transmits the encoded data block to device B (e.g., server 108). In turn, device B decodes the encoded data block using a corresponding compressive sensing decoding technique and makes corresponding changes to the copy of the data block device B is configured to access so that the data block accessible by device B is synchronized with the data block accessible by device A. Compressive sensing encoding and decoding techniques are described in more detail below with reference to FIGS. 2 and 3.

One illustrative compressive sensing encoding technique is illustrated with reference to FIG. 2, which is a flowchart of illustrative process 200 for using a compressive sensing encoding technique to encode a data block in connection with performing data synchronization. The data block may comprise any suitable type of data (e.g., a file, multiple files, at least one portion of at least one file, media content, one or more documents, and/or any other suitable data). The data block may be stored in any suitable way, and for example may be stored contiguously or non-contiguously, on one or multiple non-transitory computer readable storage media, and in any suitable format, as aspects of the disclosure provided herein are not limited in this respect. The data block may be stored on the computing device performing process 200 and/or on one or more non-transitory computer-readable storage media accessible by the computing device performing process 200. The data block may be of any suitable size and, as such, may comprise any suitable number of bits.

Process 200 may be performed by any suitable computing device or devices and, for example, may be performed by computing device 102 described with reference to FIG. 1. A computing device may perform process 200 so that a data block accessible by the computing device (e.g., a portion or all of the data stored on the computing device) may be synchronized with a copy the data block accessible by one or more other computing devices (e.g., server 108 described with reference to FIG. 1).

Process 200 begins at act 201, where an initial copy of the data block accessible by the computing device performing process 200 (“computing device A,” such as computing device 102, for example) is copied to storage accessible by another computing device (“computing device B,” such as server 108, for example). After performance of act 201 has been completed, each of computing devices A and B is configured to access identical copies of the data block and, in this respect, the copies of the data block accessible by the computing devices are synchronized.

Next process 200 proceeds to act 202, where parameters for encoding the data block are obtained. Parameters for performing encoding may include parameters for performing compressive sensing encoding of the data block, parameters for encrypting the data block being encoded, and/or any other parameters for encoding the data block.

Parameters for performing compressive sensing encoding of the data block may include plurality of random weights which may be used to encode the data block, as described with reference to act 206 below. The random weights may be obtained, at act 202, in any suitable way, as aspects of the disclosure provided herein are not limited in this respect. As one non-limiting example, the random weights may be generated by the computing device A executing process 200. As another non-limiting example, the random weights may be accessed by the computing device executing process 200 (e.g., computing device A may access random weights stored on at least one non-transitory computer readable storage medium that computing device A is configured to access). As yet another non-limiting example, the random weights may be provided, directly or indirectly, to computing device A by one or more other computing devices (e.g., by computing device B, such as server 108, with which computing device A is communicating to synchronize data).

Any suitable number of random weights may be obtained at act 202. In some embodiments, a random weight may be obtained for each of one or more portions (e.g., one or more bits, one or more bytes, or any other suitable size portion) of a data block to be encoded by the computing device. As one illustrative example, if the data block to be encoded consists of N portions (e.g., N bits, N bytes, etc.), M×N random weights may be obtained at act 202 (where N and M are each integers greater than 0). In some embodiments, M may be smaller than N. For instance, M may be less than 50% of N, less than 40% of N, less than 30% of N, less than 25% of N, less than 20% of N, less than 15% of N, less than 10% of N, less than 5% of N, or less than 3% of N. In some embodiments, the random weights may be organized in an M×N matrix Φ.

The random weights may take on any suitable values. For example, the value of a random weight may be −1, 0, or 1. As another example, the value of a random weight may be any real number between −1 and 1. As yet another example, the value of a generated weight may be any integer. As yet another example, the value of a generated weight may be any real number.

The random weights may be generated (by the computing device executing process 200 or, prior to the computing device obtaining the random weights at act 202, by any computing device(s)) according to one or more probability distributions. For example, one or more (e.g., all) random weights may be generated according to a distribution of at least one Bernoulli random variable. As another example, one or more weights may be generated according to a distribution of at least one Gaussian random variable. Though, it should be appreciated that weights may be generated according to any of numerous other types of distributions (e.g., log-Normal distribution, Rayleigh distribution, Poisson distribution, exponential distribution, uniform distribution, truncated Gaussian distribution, etc.) or in any other suitable way, as aspects of the disclosure provided herein are not limited in this respect.

Additionally, parameters for performing compressive sensing encoding of the data block may include a parameter specifying a threshold number of changes in the data block that, when made, would cause the computing device executing process 200 to encode the changed data block using a compressive sensing encoding technique and transmit the encoded data block to another computing device (e.g., server 108) with which the computing device executing process 200 communicates to synchronize data.

In some embodiments, the parameters obtained at act 202 may include one or more parameters for encrypting the data block being encoded. Parameters for encrypting the data block may include any parameters to be used for performing any suitable type of encryption technique. As one non-limiting example, parameters for encrypting the data may include a symmetric key that will be accessible (e.g., via a secure channel) to each computing device involved in performing data synchronization. The symmetric key may comprise a plurality of random weights. For example, if the data block consists of N bits, the symmetric key may be an N×N matrix Ψ of random weights.

Next process 200 proceeds to decision block 204, where it is determined whether the data block has been updated. If it is determined that the data block has not been updated, the process 200 returns to decision block 204 and monitoring of the data block for subsequent updates is continued. However, if it is determined that the data block has been updated, process 200 proceeds to act 206, where the updated data block is encoded by using a compressive sensing encoding technique.

In some embodiments, the determination that the data block has been updated may be made after a threshold number of changes have been made to the data block. As one non-limiting example, the determination that the data block consisting of N bits has been updated may be made when at least K bits have been changed (where K is an integer greater than 0 and less than or equal to N). As another non-limiting example, the data block may comprise multiple files and the determination that the data block has been updated may be made when at least a threshold number of files has been changed (e.g., deleted, added, edited, etc.). The threshold number of changes may be specified by at least one parameter obtained at act 202. It should be appreciated that the above examples of ways of determining that a data block has been updated are illustrative and non-limiting, as a determination that the data block has been updated may be made in any suitable way.

At act 206, the updated data block is encoded using a compressive sensing encoding technique to obtain an encoded updated data block. Encoding the updated data block using a compressive sensing encoding technique may comprise using the random weights obtained at act 202. In some embodiments, a data block may be encoded, in accordance with a compressive sensing encoding technique, by computing one or more random linear combinations of bits in the data block. Computing a random linear combination of bits may comprise computing a weighted sum of bits, with the bits being weighted by random weights. The random weights may be obtained in accordance with one or more suitable probability distributions, examples of which have been described.

As one non-limiting example of a compressive sensing encoding technique, a data block consisting of N bits may be encoded by calculating M random linear combinations of the N bits to produce an encoded data block consisting of M encoded bits. This may be done in any suitable way. For example, let the updated data block consisting of N bits be represented by an N×1 vector x₁. (We reserve the notation x₀ to represent the initial data block that was copied to storage accessible by computing device B at act 201). Then x₁ may be encoded to produce an M×1 vector y₁ of encoded bits by computing:

y₁=Φx₁,

where the matrix Φ is an M×N matrix, sometimes termed the “measurement matrix” or “sensing matrix”, comprising random weights, obtained at act 202, for computing the M random linear combinations. As has been previously noted, M may be smaller than N. Preferably, M may be on the order of K (e.g., M˜4K), where K is a number specifying the number of changes to be made to the data block before process 200 proceeds to encode the updated data block. Though, in other embodiments, M need not be on the order of K.

In some embodiments, encoding a data block in accordance with a compressive sensing encoding technique may additionally comprise encrypting the data block. This may be done in any suitable way. For example, in some embodiments, a symmetric key comprising a plurality of random weights may be used to encrypt the data block, as part of the encoding procedure. For example, let the updated data block consisting of N bits be represented by an N×1 vector x₁. Then x₁ may be encoded to produce an M×1 vector y₁ of encoded bits by computing:

y₁=ΦΨs₁

where the matrix Φ is an M×N matrix of random weights described above, and Ψ is an N×N matrix of random weights corresponding to the symmetric key.

After the updated data block is encoded at act 206, process 200 proceeds to act 208, where the encoded data black is transmitted to computing device B. The encoded data block may be transmitted from computing device A to computing device B in any suitable way, directly or indirectly, as aspects of the disclosure provided herein are not limited in this respect. After act 208 is performed, process 200 returns to decision block 204 to continue monitoring the data block for any subsequent updates. Acts 206 and 208 are repeated every time it is determined, at decision block 204, that the data block has been updated.

One illustrative compressive sensing decoding technique is illustrated with reference to FIG. 3, which is a flowchart of illustrative process 300 for using a compressive sensing decoding technique to decode an encoded data block in connection with performing data synchronization. The encoded data block may be obtained by using a compressive sensing encoding technique (e.g., the technique described with reference to process 200 described in FIG. 2) to encode a data block of any suitable type (examples of data blocks have been provided above).

Process 300 may be performed by any suitable computing device or devices and, for example, may be performed by server 108 described with reference to FIG. 1. A computing device may perform process 300 to synchronize a copy of a data block accessible by (e.g., stored on) computing device B with an updated version of the data block accessible by (e.g., stored on) another computing device (“computing device A,” such as computing device 102 described with reference to FIG. 1).

Process 300 begins at act 301, where a data block accessible by a computing device (“computing device A,” such as computing device 102, for example) is copied to and storage accessible by the computing device performing process 300 (e.g., “computing device B,” such as sever 108, for example). After performance of act 301 has been completed, each of computing devices A and B is configured to access identical copies of the data block. When the initial data block consists of N bits (where N is any integer greater than 0), the initial data block may be represented by an N×1 vector x₀.

Next process 300 proceeds to decision block 302, where it is determined whether an encoded updated data block has been received by the computing device performing process 300. This determination may be made in response to receiving an encoded updated data block, directly or indirectly, from another computing device (e.g., computing device A), and/or in any other suitable way, as aspects of the disclosure provided herein are not limited in this respect. When the encoded updated data block consists of M bits, the encoded updated data block may be represented by an M×1 vector y₁.

Next process 300 proceeds to act 304, where parameters for decoding the encoded updated data block y₁ are obtained. Parameters for performing the decoding may include at least some of the parameters used to encode the data block. As one non-limiting example, parameters for performing the decoding may include a plurality of random weights that were used to encode the data block. For instance, when the encoded data block was obtained by using M×N random weights (e.g., organized in an M×N matrix Φ), the parameters for performing the decoding may include these M×N random weights. As another non-limiting example, parameters for performing the decoding may include any parameters that were used to encrypt the data block as part of the encoding process. For instance, when the encoded data block was encoded at least in part by using a symmetric key (e.g., an N×N matrix Ψ of random weights), the parameters for performing the decoding may include the symmetric key.

The parameters obtained at act 304 may be obtained in any suitable way, as aspects of the disclosure provided herein are not limited in this respect. As one non-limiting example, at least some (e.g., all) of the parameters may be provided, directly or indirectly, to computing device B by one or more other computing devices (e.g., by computing device A, such as computing device 102, with which the computing device executing process 300 is communicating to synchronize data). As yet another example, at least some (e.g., all) of the parameters may be accessed by the computing device executing process 300 (e.g., computing device B may access at least some of the parameters stored on at least one non-transitory computer readable storage medium that computing device B is configured to access). As yet another example, at least some (e.g., all) of the parameters may be generated by the computing device B.

Next process 300 proceeds to acts 306-312, where the copy of the data block x₀ accessible by computing device B is updated based on information in the encoded updated data block y₁ received by computing device B. In some embodiments, this may be done at least in part by using a compressive sensing decoding technique to decode the difference between the encoded updated data block y₁ and an encoding of the data block x₀, as described in more detail below.

For clarity of presentation, suppose computing devices A and B were synchronized at act 301 so that each computing device is configured to access a respective copy of a prior (initial) data block x₀. Subsequently, computing device A determined that a threshold number of changes were made to the data block accessible by computing device A to obtain an updated data block represented by the N×1 vector x₁. Computing device A subsequently encoded the current data block x₁ (e.g., according to y₁=Φx₁ or y₁=ΦΨx₁) to obtain encoded current data block y₁ and transmitted y₁ to computing device B.

Returning to process 300, at act 306, computing device B obtains y₀—an encoded version of the prior data block x₀. In some embodiments, computing device B receives or accesses the encoded version of the prior data block. In some embodiments, computing device B calculates the encoded version of the prior data block. In some embodiments, the encoded version y₀ of the prior data block x₀ may be obtained by using the same compressive sensing encoding technique as was used to compute the encoded updated data block y₁. As one non-limiting example, when the encoded updated data block y₁ was obtained according to y₁=Φx₁, y₀ may be obtained according to y₀=Φx₀. As another non-limiting example, when y₁ was obtained according to y₁=ΦΨx₁, y₀ may be obtained according to y₀=ΦΨx₀.

After the encoded prior data block is obtained at act 306, process 300 proceeds to act 308, where the difference Δy between the encoded updated data block y₁ and the encoded prior data block y₀ is calculated. For example, Δy may be calculated according to:

Δy=y₁−y₀=Φx₁−Φx₀=Φ(x₁−x₀), or

Δy=y₁−y₀=ΦΨx₁−ΦΨx₀=ΦΨ(x₁−x₀).

Next process 300 proceeds to act 310, where the difference Δy between the encoded updated data block and the encoded prior data block is decoded using a compressive sensing decoding scheme to obtain the difference x₁−x₀. After the difference between the updated data block and the prior data block is obtained, process 300 proceeds to act 312 where the difference x₁−x₀ may be used to obtain a copy of the updated data block x₁ by using the prior data block x₀ to which computing device B has access (e.g., by computing (x₁−x₀)+x₀). After act 312 is completed, process 300 returns to decision block 304 to determine whether an encoded version of the data block (updated yet again) has been received. Acts 306-312 are repeated every time an encoded updated data block is received so that copies of the data block accessible by computing devices A and B are kept synchronized.

Any suitable compressive sensing decoding technique may be applied to decode the difference Δy between the encoded updated data block and the encoded prior data block. In some embodiments, applying a compressive sensing decoding technique to the difference between the encoded updated data block and the encoded prior data block comprises using the random weights, which were used to encode the data blocks, to perform the decoding. For example, applying the compressive sensing decoding technique may comprise using a system of equations to relate the difference (x₁−x₀) between the updated and current blocks to the difference (y₁−y₀) between the encoded updated data block and encoded prior data block. The random weights used to encode the data blocks would be coefficients of such a system of equations. In some embodiments, the difference (x₁−x₀) between the updated and prior data blocks may be obtained by solving the system of equations subject to a sparsity constraint (e.g., an 1₁ constraint) on difference between the updated and prior data blocks. In other words, a sparsity constraint would favor those solutions to the system of equations in which only a small number of changes have been made to the prior data block x₀ to obtain the updated (current from the perspective of computing device A) data block x₁. In some embodiments, the system of equations may be used as an equality constraint in an optimization problem in which the objective function is the 1₁ norm (e.g., sum of absolute values) of the difference between the updated and prior blocks.

As one non-limiting example, using a compressive sensing decoding technique to solve for the difference (x₁−x₀) between the updated and prior data blocks based on the difference (y₁−y₀) between the encoded updated data block and the encoded prior data block may comprise identifying solution(s) to the following optimization problem:

$${min}_{( {x}_{1} - {x}_{0} ) ∈ {R}^{N}} {‖ {x}_{1} - {x}_{0} ‖}_{{l}_{1}}$$

$$subject to {y}_{1} - {y}_{0} = Φ Ψ ( {x}_{1} - {x}_{0} )$$

where the x₀ is an N×1 vector representing the prior data block, x₁ is an N×1 vector representing the updated data block, y₀ is an M×1 vector representing the encoded prior data block, y₁ is an M×1 vector representing the encoded updated data block, Φ is an M×N measurement matrix comprising a plurality of random bits, and Ψ is an N×N matrix representing a symmetric key used for encryption during encoding. The above optimization problem comprises an objective function (i.e., minimizing the 1₁ norm of (x₁−x₀)) and multiple equality constraints.

When the difference x₁−x₀ has a small number K<N of non-zero values, results about properties of compressive sensing decoding techniques known in the art indicate that the solution of the above-formulated optimization problem may, with high probability, have K non-zero values (corresponding to the K differences between the prior and updated data blocks). For example, when K<N and M is greater than or equal to cK (with c greater than or equal to three), the solution of the above-formulated optimization problem may, with high probability, accurately obtain a solution X₁−x₀ having K non-zero values.

The above-described optimization problem and variants thereof may be solved in any suitable way. For example, in some embodiments, the above-described optimization problem may be solved using any suitable linear programming technique(s). To this end, one or more software packages implementing these linear programming techniques may be utilized. For example, in some embodiments, one or more compressive sensing software packages, numerical linear algebra software packages, and/or any other suitable software may be used. It should be appreciated that the above-described optimization problem may be parallelized and, as such, may be solved at least in part by one or more processors and/or one or more graphical processing units.

It should also be appreciated that the above-described optimization problem is an illustrative example of how a compressive sensing decoding technique may be applied and that applying a compressive sensing decoding technique may comprise solving a different optimization problem or problems, as aspects of the disclosure provided herein are not limited in this respect.

Having thus described several aspects and embodiments of the technology described in the application, it is to be appreciated that various alterations, modifications, and improvements will readily occur to those skilled in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present application involving the performance of methods may utilize program instructions executable by a device (e.g., a computer, a hardware processor, or other device) to perform, or control performance of, the methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments discussed above. The computer readable medium or media can be transportable, such that the program or programs stored thereon can be loaded onto one or more different computers or other processors to implement various ones of the aspects discussed above. In some embodiments, computer readable media may be non-transitory media.

The terms “program” or “software” are used herein in a generic sense to refer to any type of computer code or set of computer-executable instructions that can be employed to program a computer or other processor to implement various aspects as discussed above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

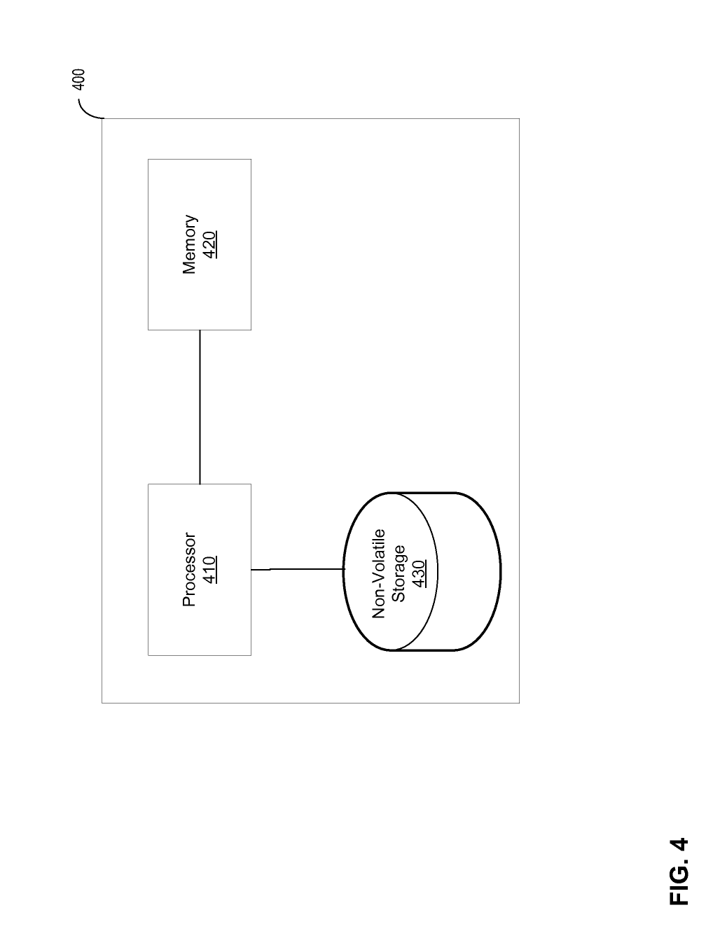

A computer system that may be used in connection with any of the embodiments of the invention described herein is shown in FIG. 4. The computer system may include one or more processors 410 and one or more non-transitory computer-readable storage media (e.g., memory 420 and one or more non-volatile storage media 430). The processor 410 may control writing data to and reading data from the memory 420 and the non-volatile storage device 430 in any suitable manner, as the aspects of the invention described herein are not limited in this respect. To perform any of the functionality described herein, the processor 410 may execute one or more instructions stored in one or more computer-readable storage media (e.g., the memory 420), which may serve as non-transitory computer-readable storage media storing instructions for execution by the processor 410.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as discussed, some aspects may be embodied as one or more methods including, but not limited to, any method including steps described with reference to illustrative processes 200 and 300 and FIGS. 2 and 3. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A method for data synchronization between a first computing device coupled to at least one memory storing current data and a second computing device, the method performed by the first computing device, the method comprising:
encoding the current data using a compressive sensing encoding technique to obtain first encoded data; and
transmitting the first encoded data to the second computing device.

2. The method of claim 1, further comprising:
in response to determining that at least a threshold number of changes have been made to the current data to produce updated data, encoding the updated data using the compressive sensing encoding technique to obtain second encoded data; and
transmitting the second encoded data to the second computing device.

3. The method of claim 1, wherein the current data comprises a plurality of bits, the first encoded data comprises a plurality of encoded bits, and wherein encoding the current data using the compressive sensing encoding technique comprises:
calculating a plurality of random linear combinations of bits in the plurality of bits to obtain the plurality of encoded bits.

4. The method of claim 3, wherein calculating the plurality of random linear combinations of bits comprises:
calculating at least one weighted sum of bits in the first plurality of bits, with bits being weighted by weights obtained at least in part by using at least one probability distribution.

5. The method of claim 4, wherein the at least one probability distribution comprises a distribution of a Bernoulli random variable and/or a distribution of a Gaussian random variable.

6. The method of claim 4, further comprising:
transmitting the weights obtained at least in part by using at least one probability distribution to at least the second computing device.

7. The method of claim 1, wherein the first computing device is a mobile device.

8-9. (canceled)

10. A system for data synchronization, comprising:
at least one computing device; and
at least one memory storing processor-executable instructions that, when executed by the at least one computing device, cause the at least one computing device to:
encode current data using a compressive sensing encoding technique to obtain first encoded data; and
transmit the first encoded data to at least a second computing device.

11. The system of claim 10, wherein the at least one computing device is further configured to:
in response to determining that at least a threshold number of changes have been made to the current data to produce updated data, encode the updated data using the compressive sensing encoding technique to obtain second encoded data; and
transmit the second encoded data to at least the second computing device.

12. The system of claim 10, wherein the current data comprises a plurality of bits, the first encoded data comprises a plurality of encoded bits, and wherein the at least one computing device is configured to encode the current data using the compressive sensing encoding technique at least in part by:
calculating a plurality of random linear combinations of bits in the plurality of bits to obtain the plurality of encoded bits.

13. The system of claim 12, wherein calculating the plurality of random linear combinations of bits comprises:
calculating at least one weighted sum of bits in the first plurality of bits, with bits being weighted by weights obtained at least in part by using at least one probability distribution.

14. The system of claim 13, wherein the at least one probability distribution comprises a distribution of a Bernoulli random variable and/or a distribution of a Gaussian random variable.

15. The system of claim 13, wherein the at least one computing device is further configured to:
transmit the weights obtained at least in part by using at least one probability distribution to at least the second computing device.

16. The system of claim 10, wherein the at least one computing device comprises a mobile device.

17-27. (canceled)

28. A method for data synchronization between a first computing device coupled to at least a first memory storing current data and at least a second computing device coupled to at least a second memory storing first encoded data and a copy of prior data, the method performed by the second computing device, the method comprising:
receiving second encoded data from the first computing device;
decoding the second encoded data using a compressive sensing decoding technique to obtain decoded data; and
obtaining a copy of the current data by using the decoded data and the copy of prior data.

29. The method of claim 28, wherein decoding the second encoded data further comprises using the first encoded data to perform the decoding.

30. The method of claim 29, wherein decoding the second encoded data comprises:
applying the compressive sensing decoding technique to a difference between the second encoded data and the first encoded data.

31. The method of claim 28, further comprising:
receiving a plurality of weights from the first computing device, wherein the plurality of weights were used to obtain the first encoded data and the second encoded data.

32. The method of claim 28, further comprising:
storing the second encoded data in at least the second memory.

33. The method of claim 28, wherein the first computing device is a mobile device.

34-48. (canceled)
